(19) United States
(12) Patent Application Publication
(10) Pub. No.: US 2021/0407017 A1
(43) Pub. Date: Dec. 30, 2021

(54) MINIMIZING REGRET THROUGH ACTIVE LEARNING FOR TRANSACTION CATEGORIZATION

(71) Applicant: INTUIT INC., Mountain View, CA (US)

(72) Inventors: Christopher Z. LESNER, Palo Alto, CA (US); Alexander S. RAN, Palo Alto, CA (US); Kristin COOPER, Mountain View, CA (US)

(21) Appl. No.: 16/912,843

(22) Filed: Jun. 26, 2020

(51) Int. Cl. G06Q 40/00; G06N 20/00; G06Q 40/02

(52) U.S. Cl. CPC G06Q 40/12; G06Q 40/02; G06N 20/00

(57) ABSTRACT

Aspects of the present disclosure provide techniques for training a machine learning model. Embodiments include determining a set of unlabeled user transaction records associated with a user. Embodiments include selecting a first unlabeled user transaction record associated with a first vendor from the set of unlabeled user transaction records based on a transaction record prioritization scheme. Embodiments include presenting the first unlabeled user transaction record to the user in a label query. Embodiments include receiving, from the user in response to the label query, a label of a first account for the first unlabeled user transaction record. Embodiments include selecting a second unlabeled user transaction record associated with a second vendor from the set of unlabeled user transaction records based on: the transaction record prioritization scheme; and a determination that the second vendor is least likely to be categorized by the user in the first account.

### INTRODUCTION

Aspects of the present disclosure relate to techniques for transaction categorization through active learning.

### BACKGROUND

Every year millions of people, businesses, and organizations around the world use electronic financial management systems, such as electronic accounting systems, to help manage their finances. Electronic accounting systems use accounts for categorization of business transactions. Such electronic accounting systems gather data related to financial transactions of the users. The users can then sort the financial transactions into the various accounts in order to track their expenditures and revenues by category. The users can monitor many or all of their financial transactions and other financial matters from a single electronic accounting system and sort them into the various financial accounts. Such an electronic accounting system can help users save time by eliminating the need to check with several different financial institutions in order to manage their finances. However, traditional financial management systems are unable to optimize the services provided to their users because the traditional financial management systems do not discern the nature and purpose of each account that the users create.

For instance, some traditional financial management systems enable users to generate and name the various accounts into which the users will sort their financial transactions. A certain user may have an account for employee travel expenses, an account for office supply expenses, an account for office furniture expenses, etc. The user may know the exact purpose of each account, but the conventional financial management system will not know the exact purpose of the accounts. While the user may be able to sort the various financial transactions into the account, the financial management system cannot adequately assist in the sorting process because the financial management system does not understand the purpose of each account.

One reason for these deficiencies is that in most cases the accounts, and the names of the accounts, are selected by the users and used differently by different users. Two users may each have an account named “Furniture”. The first user may use this account for revenue related to sales of furniture. The second user may use this account for expenses related to purchasing office furniture. Additionally, users may use nearly infinite variations of names for accounts that all serve the same general purpose. Consequently, the financial management system cannot know the true nature of an account based only the name.

When a new user first attaches their accounts to a financial management system, they may be excited by all of the transactions that are automatically downloaded for them, but not excited about all of the work they will have to do to categorize each of these downloaded transactions into their accounts. Due to the inability of conventional financial management systems to adequately understand the nature of the new user's accounts based solely on the names of the accounts, these systems will be unable to accurately perform automatic categorization of the user's transactions into the user's accounts. This is particularly problematic when the new user first attaches their accounts to the financial management system because during first use the number of transactions that a user must categorize is greatest. New users may be faced with many screens full of several months of transactions. Having to manually review and pick an account for each one discourages new users. Furthermore, during first use the relationship of a given user with the financial management system is most tenuous and the risk of customer abandonment is highest.

What is needed is a solution for improved learning of user accounts for accurate automatic categorization of transactions, particularly for users who are new to a financial management system.

### BRIEF SUMMARY

Certain embodiments provide a method for training a machine learning model using active learning. The method generally includes: determining a set of unlabeled user transaction records associated with a user, wherein each unlabeled user transaction record in the set of unlabeled user transaction records is not yet labeled with an account of a set of accounts associated with the user; selecting a first unlabeled user transaction record associated with a first vendor from the set of unlabeled user transaction records based on a transaction record prioritization scheme; presenting the first unlabeled user transaction record to the user in a label query; receiving, from the user in response to the label query, a label of a first account of the set of accounts for the first unlabeled user transaction record; selecting a second unlabeled user transaction record associated with a second vendor from the set of unlabeled user transaction records based on: the transaction record prioritization scheme; and a determination that the second vendor is least likely to be categorized by the user in the first account of the set of accounts.

Other embodiments provide a method for training a machine learning model. The method generally includes: receiving transaction categorization data comprising a plurality of transaction records of a plurality of users categorized into a plurality of accounts of the plurality of users; determining a set of unlabeled user transaction records associated with a user; determining popularities of vendors in the set of transaction records associated with the user based on occurrences of the vendors in the plurality of transaction records of the plurality of users; determining categorization consistencies of the vendors in the transaction categorization data; selecting a first transaction record of the set of transaction records to display to the user for categorization based on the popularities of the vendors and the categorization consistencies of the vendors; displaying the first transaction record; and receiving, in response to the displaying, a categorization of the first transaction record into a given account of a set of accounts of the user.

Other embodiments provide a system comprising one or more processors and a non-transitory computer-readable medium comprising instructions that, when executed by the one or more processors, cause the system to perform a method. The method generally includes: receiving transaction categorization data comprising a plurality of transaction records of a plurality of users categorized into a plurality of accounts of the plurality of users; determining a set of unlabeled user transaction records associated with a user; determining popularities of vendors in the set of transaction records associated with the user based on occurrences of the vendors in the plurality of transaction records of the plurality of users; determining categorization consistencies of the vendors in the transaction categorization data; selecting a first transaction record of the set of transaction records to display to the user for categorization based on the popularities of the vendors and the categorization consistencies of the vendors; displaying the first transaction record; and receiving, in response to the displaying, a categorization of the first transaction record into a given account of a set of accounts of the user.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment for transaction categorization through active learning.

FIG. 2 depicts an example user interface for transaction categorization.

FIG. 3 depicts an example of transaction categorization through active learning.

FIG. 4 depicts another example user interface for transaction categorization.

FIG. 5 depicts example operations for transaction categorization through active learning.

FIGS. 6A and 6B depict example processing systems for transaction categorization through active learning.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for active learning for transaction categorization.

Embodiments described herein may utilize machine learning techniques to automatically categorize user transactions into user accounts, such as for financial management purposes. In some cases, historical transaction categorization data of a plurality of users can be used to learn how certain types of transactions tend to be categorized. However, different users may use accounts for different purposes, and/or may give different names to accounts. As such, it is difficult to automatically categorize transactions into accounts for a particular user without first learning how that particular user utilizes specific accounts. This learning process can take time, and a machine learning model will generally will become increasingly accurate as a user continues to use the application. Techniques described herein involve minimizing the amount of incorrectly categorized transactions, which may be referred to as minimizing “regret”, through active learning.

Every transaction a user categorizes reveals some information about how they use their chart of accounts to organize their transactions. However, not every categorized transaction reveals the same amount of information. For example, when a user is filing transactions in chronological order they may be asked to file transactions: (a) John's Coffee Chop $8, (b) Coffee House $7, (c) The Coffee Cup $9, (d) Quick Fuel $35, (e) Gas N Go $38, and (f) Pit Stop Fuel $45.

As soon as transaction (a) is assigned to an account, there is a high probability that the next two, (b) and (c), belong in the same account. Thus, rather than prompting the user to continue transaction review in chronological order, it is better to change the transaction review order such that the next transaction presented is not (b) or (c), but perhaps (d), (e), or (f).

The fundamental challenge is how to present transactions to users such that each transaction reveals the most information possible about how to categorize the remaining transactions.

Embodiments of the present disclosure utilize active learning to improve the speed and accuracy of training a machine learning model to categorize transactions for a user. Active learning generally refers to techniques in which an algorithm is used to determine which data point to test next based on which data points are likely to provide the most valuable insight into the overall data set. In particular, techniques described herein involve assigning priorities to uncategorized transactions based on which transactions are likely to provide the most insight into a user's accounts. By providing transactions to a user for categorization in an order that is based on the assigned priorities, embodiments of the present disclosure allow higher-value training data to be generated more quickly, and thereby allow a machine learning model to be trained to output accurate results sooner than conventional techniques.

Various factors may be used to determine which transactions are likely to provide the most insight into a user's accounts. One such factor is vendor popularity. Transactions involving vendors that are popular, such as for a given user or in the given user's geographic region, may be prioritized due to the fact that there are likely to be many transactions involving these popular vendors. Once the user has categorized one transaction involving a given vendor into a given account, this user feedback is likely to be applicable to additional transactions involving the vendor. If the given vendor is a popular vendor for the given user or in the given user's geographic region, then the additional transactions to which the user feedback will be applicable are likely to be numerous, thus rendering the user feedback more valuable.

Another factor is vendor likelihood of co-categorization. Some vendors provide specific types of goods and/or services (e.g., restaurants), and it is likely that most transactions involving these vendors will be co-categorized into the same account. However, other vendors provide a wide variety of goods and/or services (e.g., department stores), and transactions involving these vendors may be categorized into many different accounts. For example, transactions involving an airline are more likely to be co-categorized (e.g., into a travel-related account) than transactions involving an online retailer that sells many different types of products (e.g., which may be categorized into a variety of different accounts). As such, transactions involving vendors with a high likelihood of co-categorization may be prioritized due to the fact that user feedback for one of these transactions is likely to have wider applicability to other transactions with the same vendor.

Yet another factor is the likelihood of a given transaction to be co-categorized with transactions that a given user has already categorized. In some embodiments, transactions least likely to be co-categorized with transactions already categorized by the given user are prioritized in order to reduce capturing redundant data points.

Other factors may be considered as well, and a priority may be determined for each transaction of a given user. Accordingly, the highest priority transactions may be displayed to the user for categorization first so that a machine learning model may be trained as quickly as possible to accurately perform automatic categorization of subsequent transactions.

It is noted that presenting several transactions of a similar type to a machine learning model may help it become more accurate at categorizing that type of transaction, but will not help the machine learning model learn other types of transactions. Techniques described herein are aimed at creating diversity of training data at the front end so that automatic categorization is able to function more quickly after the user begins use of the application. In particular, embodiments of the present disclosure allow diverse and useful data points to be gathered quickly and used to train a machine learning model to automatically categorize transactions as quickly as possible after a user begins use of the application.

### Example Computing Environment

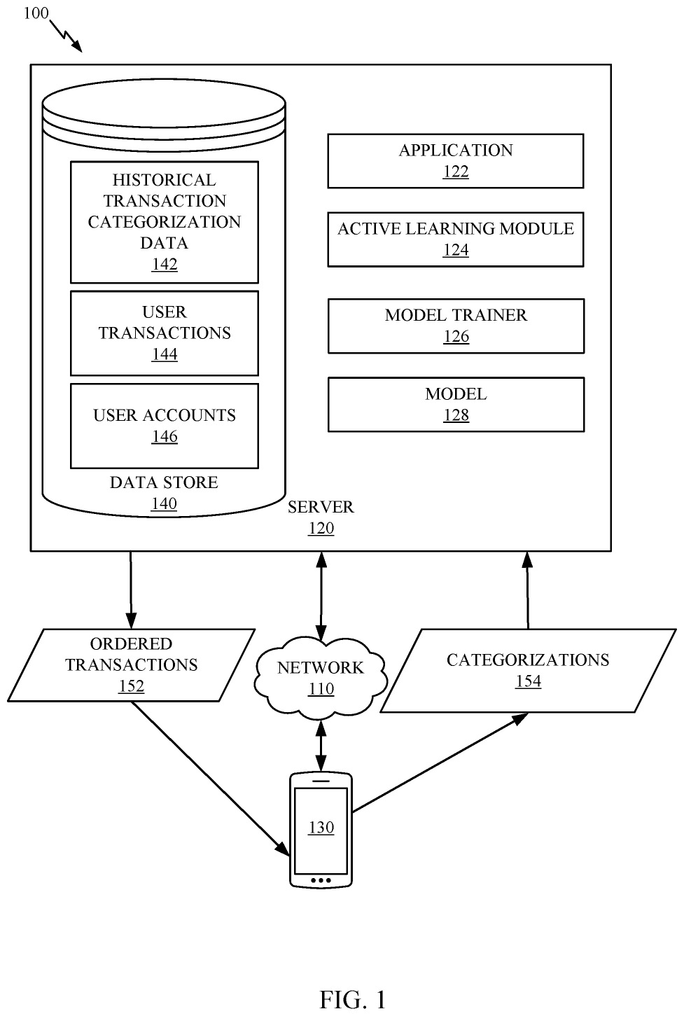

FIG. 1 illustrates an example computing environment 100 for transaction categorization using active learning.

Computing environment 100 includes a server 120 and a client 130 connected over network 110. Network 110 may be representative of any type of connection over which data may be transmitted, such as a wide area network (WAN), local area network (LAN), cellular data network, and/or the like.

Server 120 generally represents a computing device such as a server computer. Server 120 includes an application 122, which generally represents a computing application that a user interacts with over network 110 via client 130. In some embodiments, application 122 is accessed via a user interface associated with client 130. In one example, application 122 comprises a financial management system that is configured to provide financial management services to a plurality of users.

According to one embodiment, application 122 is an electronic financial accounting system that assists users in book-keeping or other financial accounting practices. Additionally, or alternatively, the financial management system can manage one or more of tax return preparation, banking, investments, loans, credit cards, real estate investments, retirement planning, bill pay, and budgeting. Application 122 can be a standalone system that provides financial management services to users. Alternatively, the application 122 can be integrated into other software or service products provided by a service provider.

In one embodiment, application 122 can assist users in tracking expenditures and revenues by retrieving financial transaction data (e.g., user transactions 144) related to financial transactions of users and by enabling the users to sort the financial transactions into accounts (e.g., user accounts 146). Each user can have multiple accounts into which the user's financial transactions can be sorted, which may be referred to as the user's “chart of accounts”. Application 122 enables the users to generate and name their various accounts and to use the accounts for their own financial tracking purposes. Because the names and purposes of the accounts are user generated, the types of accounts, or the way the user uses the accounts, may not be properly discernible by application 122 based only on the names of the accounts. As such, techniques described herein involve increasing the speed at which a machine learning model learns to categorize transactions of a user through active learning. In particular, embodiments involve determining an order in which to provide transactions to a user for categorization based on which transactions are likely to provide the most insight into the user's chart of accounts and thus will result in the efficient generation of diverse and useful training data for the model.

Server 120 includes an active learning module 124, which generally performs operations related to prioritizing transactions for categorization in order to generate training data according to techniques described herein. In some embodiments, active learning module 124 determines priorities for each transaction of a user of application 122 (e.g., user transactions 144) for use in determining an order in which to provide the transactions 152 to the user for review and categorization, such as via a user interface associated with client 130. The categorizations 154 by the user of the transactions into user accounts (e.g., user accounts 146) are used to generate training data, which is used by model trainer 126 to train a model 128 for automatically categorizing subsequent transactions. Model 128 may, for example, be a machine learning model.

Machine-learning models allow computing systems to improve and refine functionality without explicitly being programmed. Given a set of training data, a machine-learning model can generate and refine a function that determines a target attribute value based on one or more input features. For example, if a set of input features describes an automobile and the target value is the automobile's gas mileage, a machine-learning model can be trained to predict gas mileage based on the input features, such as the automobile's weight, tire size, number of cylinders, coefficient of drag, and engine displacement.

The predictive accuracy a machine-learning model achieves ultimately depends on many factors. Ideally, training data for the machine-learning model should be representative of the population for which predictions are desired (e.g., unbiased and correctly labeled). In addition, training data should include a substantive number of training instances relative to the number of features on which predictions are based and relative to the range of possible values for each feature. Techniques described herein involve the use of active learning in order to generate diverse and useful training data. Prioritizing transactions for categorization by a user based on which transactions are likely to provide the most insight into a user's chart of accounts allows for more valuable training data to be generated in a shorter amount of time, as each consecutive transaction is selected based on factors indicative of the insight the transaction's categorization by the user will provide into the user's chart of accounts.

There are many different types of supervised and unsupervised machine-learning models that can be used in embodiments of the present disclosure. For example, a model 128 may be a neural network, a support vector machine, a Bayesian belief network, a regression model, or a deep belief network, among others. Models may also be an ensemble of several different individual machine-learning models. Such an ensemble may be homogenous (i.e., using multiple member models of the same type, such as a random forest of decision trees) or non-homogenous (i.e., using multiple member models of different types). Individual machine-learning models within such an ensemble may all be trained using the same subset of training data or may be trained using overlapping or non-overlapping subsets randomly selected from the training data.

A decision tree makes a classification by dividing the inputs into smaller classifications (at nodes), which result in an ultimate classification at a leaf.

A random forest extends the concept of a decision tree model, except the nodes included in any give decision tree within the forest are selected with some randomness. Thus, random forests may reduce bias and group outcomes based upon the most likely positive responses.

A Naïve Bayes classification model is based on the concept of dependent probability i.e., what is the chance of some outcome given some other outcome.

A logistic regression model takes some inputs and calculates the probability of some outcome, and the label may be applied based on a threshold for the probability of the outcome. For example, if the probability is >50% then the label is A, and if the probability is <=50%, then the label is B.

Gradient boosting is a method for optimizing decision-tree based models.

Neural networks generally include a collection of connected units or nodes called artificial neurons, which loosely model the neurons in a biological brain. The operation of neural networks can be modeled as an iterative process. Each node has a particular value associated with it. In each iteration, each node updates its value based upon the values of the other nodes, the update operation typically consisting of a matrix-vector multiplication. The update algorithm reflects the influences on each node of the other nodes in the network.

In one example, training data for use by model trainer 126 in training model 128 includes sets of features related to transactions associated with labels indicating accounts into which the transactions were categorized. As such, when a categorization 154 of a given transaction 152 is received, the account indicated in the categorization 154 is used as a label for a training data instance including features of the given transaction 152.

In some embodiments, training model 128 involves providing training inputs (e.g., sets of features) to nodes of an input layer of model 128. Model 128 processes the training inputs and outputs indications of predicted accounts into which transactions represented by the features are to be categorized. The outputs are compared to the labels associated with the training inputs to determine the accuracy of model 128, and parameters of model 128 are iteratively adjusted until one or more conditions are met.

For example, the conditions may relate to whether the predictions produced by model 128 based on the training inputs match the labels associated with the training inputs or whether a measure of error between training iterations is not decreasing or not decreasing more than a threshold amount. The conditions may also include whether a training interaction limit has been reached. Parameters adjusted during training may include, for example, hyperparameters, values related to numbers of iterations, weights, functions, and the like. In some embodiments, validation and testing are also performed for model 128, such as based on validation data and test data, as is known in the art. Using active learning as described herein allows valuable and diverse training data to be generated quickly and used to train model 128 either through batch training (e.g., each time a threshold number of training data instances have been generated) or through online training (e.g., re-training model 128 with each new training data instance as it is generated).

Data store 140 generally represents a data storage entity such as a database or repository that stores historical transaction categorization data 142, user transactions 144, and user accounts 146. Historical transaction categorization data 142 generally includes records of categorizations of transactions into accounts by a plurality of users of application 122. User transactions 144 include the transactions of a given user (e.g., the user of client 130), which may be received (e.g., downloaded from one or more sources) at the time the given user first uses application 122. User accounts 146 include the given user's chart of accounts, which also may be received (e.g., via user input) at the time the given user first uses application 122. User transactions 144 and user accounts 146 may be updated over time as new transactions and new accounts are received for the given user. Similarly, historical transaction categorization data 142 may be updated over time as categorizations 154 are received from the given user.

Client 130 generally represents a computing device such as a mobile phone, laptop or desktop computer, tablet computer, or the like. Client 130 is used to access application 122 over network 110, such as via a user interface associated with client 130. In alternative embodiments, application 122 (and, in some embodiments active learning module 124, model trainer 126, model 128, and/or data store 140) is located directly on client 130.

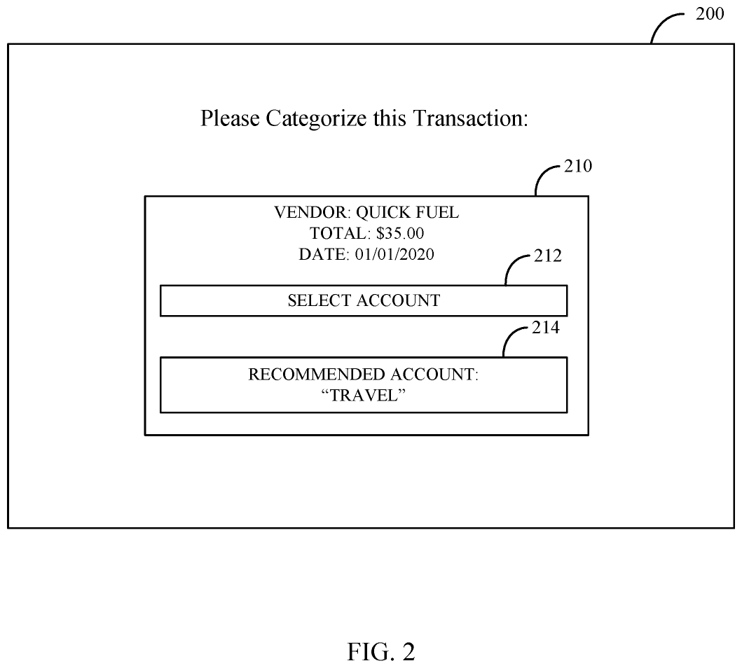

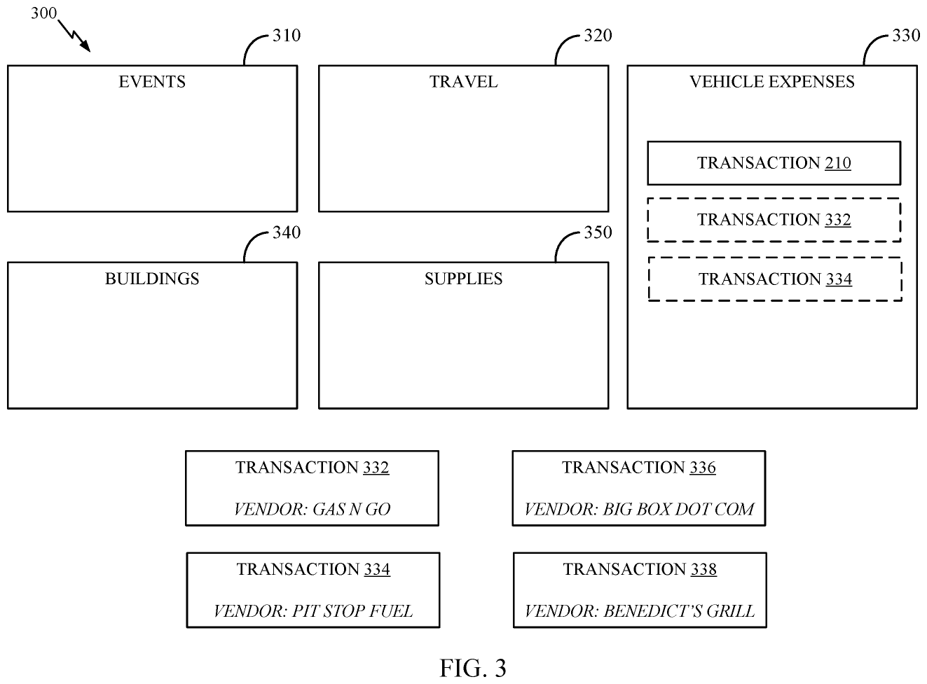

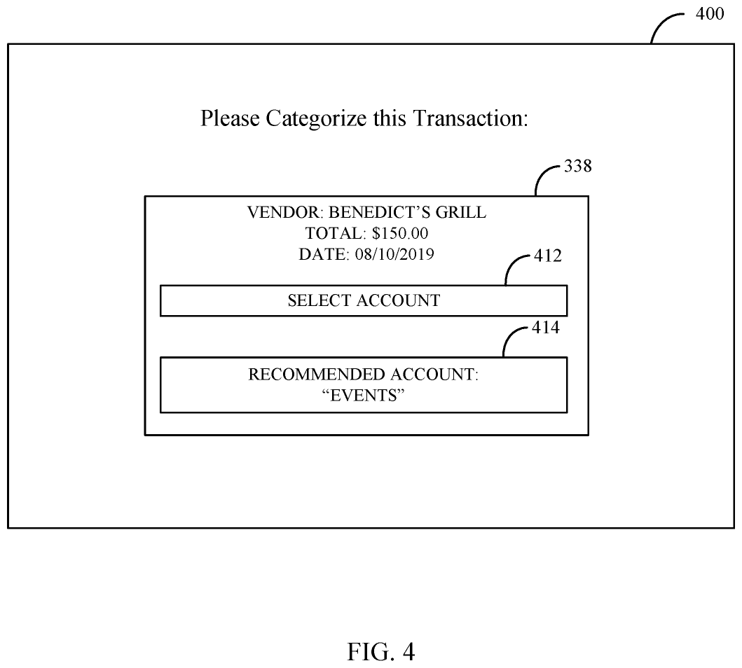

In one embodiment, active learning module 124 determines priorities for each user transaction 144, and the priorities are used to determine an order in which to provide ordered transactions 152 to client 130 for categorization. Displaying transactions for categorization is described in more detail below with respect to FIGS. 2 and 4, and categorization of transactions into accounts is described in more detail below with respect to FIG. 3. In some embodiments, the priority for a given transaction is determined based on a combination of factors.

In one embodiment, a greedy algorithm is employed. A greedy algorithm generally refers to an algorithm in which the locally optimal choice is made at each stage with the intent of finding a global optimum. In the present case, first a prioritization scheme is used to select the highest-priority transaction to be the first transaction that the user reviews. Then, for each subsequent transaction that the user is to review, the next most-prioritized transaction that is least likely to be categorized into the same accounts as transactions categorized so far is selected.

In one example, the transaction prioritization scheme can include a combination of: (1) vendor popularity for the given user; (2) vendor popularity for the given user's region (e.g., city or other geographic area); (3) vendor co-categorization probability with vendors in transactions that have already categorized; (4) categorization consistency of the vendor; and/or (5) confidence estimates of (1)-(4) above. Confidence estimates may, for example, be based on an amount of data on which each of (1)-(4) are based. For instance, if categorization consistency is determined for a vendor based only on a small number of historical categorizations of transactions involving the vendor, then the confidence estimate for the categorization consistency may be low. Conversely, if categorization consistency is determined for the vendor based on a large number of historical categorizations of transactions involving the vendor, then the confidence estimate for the categorization consistency may be high.

Vendor popularity for the given user may be determined based on how many times the vendor appears in the user transactions 144 of the user. This can be determined quickly after importing a user's transactions without requiring the user to provide any additional input. Vendor popularity for the given user's region may be determined based on how many times the vendor appears in a subset of historical transaction categorization data 142 that corresponds to users in the given user's region. In some embodiments, disambiguation is performed for vendors appearing in the user transactions 144 of the user as well as in historical transaction categorization data 142. For example, different local stores (e.g., franchises) of an umbrella company may have different names (e.g., Company A—Store 1 and Company A—Store 2). Furthermore, a vendor may appear differently in records of transactions from different sources, such as from different banks. For example, a first bank may use an abbreviation, while a second bank may use the full name of the vendor. Various disambiguation techniques may be employed, such as involving additional machine learning models, textual analysis, edit distances, and/or the like.

Vendor co-categorization probability with vendors in transactions that have already been categorized may be determined based on how frequently the vendor is co-categorized in historical transaction categorization data 142 with vendors that are in any transactions already categorized by the given user. Categorization consistency may be determined based on how frequently transactions involving the vendor are co-categorized (e.g., multiple transactions from the same vendor are categorized into the same account) by users in historical transaction categorization data 142.

A priority for a given transaction may be determined based on any number of factors (1)-(5) above, and/or additional factors. In some embodiments, different factors are weighted differently when determining a priority, such as based on pre-determined weights.

In certain embodiments, ordered transactions 152 are provided to client 130 one at a time so that each subsequent transaction can be selected based on previously categorized transactions. In other words, ordered transactions 152 may represent a series of transactions provided to the user one-at-a-time, each subsequent ordered transaction 152 being selected according to the greedy algorithm described herein after the previous ordered transaction 152 has been categorized by the user.

In one example, a first ordered transaction 152 (e.g., a highest priority transaction of user transactions 144) is provided to the user, and a second ordered transaction 152 is not provided to the user until a categorization 154 of the first ordered transaction 152 has been received. The second ordered transaction 152 provided to client 130 may be determined by selecting the highest priority transaction of user transactions 144 that is least likely to be co-categorized with the first transaction, such as by determining that a vendor of the second ordered transaction 144 is infrequently or never co-categorized with a vendor of the first ordered transaction 144 by users in historical transaction categorization data 142. Each subsequent ordered transaction 152 may be selected in a similar way. Accordingly, model 128 can be trained more quickly with a diverse and valuable set of training data samples determined through active learning.

Once a sufficient amount of categorizations 154 have been received (e.g., in the case of batch learning), or after each categorization 154 is received (e.g., in the case of online learning), training data is generated based on categorizations 154, and the training data is used by model trainer 126 to train model 128. As such, model 128 may be used to determine recommended accounts into which transactions should categorized, and the recommended accounts may be provided to the user.

### Example User Interface for Transaction Categorization

FIG. 2 depicts an example screen 200 of a user interface for transaction categorization. For example, screen 200 may be displayed on client 130 of FIG. 1, and may correspond to application 122 of FIG. 1.

Screen 200 includes a prompt to categorization a transaction 210. Transaction 210 may, for example, be a first ordered transaction 152 of FIG. 1, which may have been selected for review by a given user based on priorities assigned to user transactions 144 of FIG. 1.

Transaction 210 has a vendor named “Quick Fuel”, a total of “$35.00”, and a date of “01/01/2020”. A priority of transaction 210 may have been determined based on a popularity of the vendor “Quick Fuel” for the given user and in the given user's region, and a categorization consistency of the vendor “Quick Fuel”. For example, “Quick Fuel” may be a popular vendor for the given user and/or in the given user's region, and/or “Quick Fuel” may have a high categorization consistency (e.g., users may frequently co-categorize transactions involving “Quick Fuel”, such as in accounts related to travel expenses).

Screen 200 includes a user interface control 212 that allows an account to be selected for transaction 210. Selecting control 212 may, for example, cause a window or menu to be displayed that lists the accounts of the given user and/or provides controls for adding a new account into which transaction 210 may be categorized. Screen 200 also includes a control 214 that, when selected, causes transaction 210 to be categorized into a recommended account. In this case, the recommended account is “Travel”. The recommended account may have been determined by providing features of transaction 210 as inputs to model 128 of FIG. 1, and receiving the recommended account as an output from model 128 of FIG. 1. Because transaction 210 is the first transaction provided to the given user for categorization, model 128 may not yet have been trained with training data specific to the given user. In some embodiments, model 128 of FIG. 1 may have already been trained based only on categorizations performed by other users, but may not have developed an understanding of the given user's chart of accounts.

Once the user categorizes transaction 210, such as by selecting an account via control 212 or selecting the recommended account via control 214, the user's categorization of transaction 210 is used to generate training data for training model 128 of FIG. 1. Because transaction 210 was prioritized for display to the user based on factors such as vendor popularity and vendor categorization consistency, the categorization of transaction 210 will provide valuable insight into the user's chart of accounts, and may allow other transactions of the user to be automatically categorized in an accurate manner.

FIG. 3 depicts an example embodiment 300 of transaction categorization using active learning.

Embodiment 300 includes a plurality of accounts 310, 320, 330, 340 (e.g., as part of a chart of accounts), and 350 and a plurality of transactions 210, 332, 334, 336, and 338 of a given user. For example, accounts 310, 320, 330, 340, and 350 may correspond to user accounts 146 of FIG. 1 and transactions 210, 332, 334, 336, and 338 may correspond to user transactions 144 of FIG. 1. Transaction 210 may correspond to transaction 210 of FIG. 2, and may have been categorized by the given user as described above with respect to FIG. 2. For example, the given user may have selected control 212 of FIG. 2 to categorize transaction 210 into an account 330 named “Vehicle Expenses”.

Transactions 332 and 334, including vendors “Gas N Go” and “Pit Stop Fuel” may have a high likelihood of being co-categorized with transaction 210, which included the vendor “Quick Fuel”, as all three of these vendors are gas stations. For example, transactions involving all three of these vendors may have been frequently co-categorized by users in historical transaction categorization data 142 of FIG. 1. As such, the user's categorization of transaction 210 into account 330 indicates that the user is likely to categorize transactions 332 and 334 into account 330 as well. Regardless of the priorities assigned to transactions 332 and 334, neither of these transactions is likely to be selected as the next transaction to display to the given user due to the fact that these transactions have a high probability of co-categorization with a transaction 210 that has already been categorized. Accordingly, one of transactions 336 or 338 will be selected as the next transaction to display to the given user.

Transaction 336 includes the vendor “Big Box Dot Com” and transaction 338 includes the vendor “Benedict's Grill”. It may be the case that “Big Box Dot Com” is a more popular vendor than “Benedict's Grill”, as it appears to be a large online retailer. However, it is also likely that “Big Box Dot Com” has a lower categorization consistency than “Benedict's Grill” because “Big Box Dot Com” likely sells a variety of different types of products while “Benedict's Grill” likely sells only food. In one example, vendor categorization consistency is weighted more heavily than vendor popularity in the priority calculation, and so transaction 338 is assigned a higher priority for categorization than transaction 336.

Because the given user has only categorized a transaction into one account 330 so far, only the names of the other accounts 310, 320, 340, and 350 are known at this point. Account 310 is named “Events”, account 320 is named “Travel”, account 340 is named “Buildings”, and account 350 is named “Supplies”. Determining which account the given user categorizes transaction 338 into will provide valuable training data that, when used to train the model, will allow the model to accurately categorize other transactions involving restaurants.

FIG. 4 depicts another screen 400 of a user interface for transaction categorization. For example, screen 400 may be displayed after screen 200 of FIG. 2, and may include a second transaction for categorization by a given user.

Screen 400 prompts the given user to categorize transaction 338. For example, transaction 338 may have been selected based on priority and a determination that transaction 338 is unlikely to be co-categorized with transactions that have already been categorized, as described above. Transaction 338 includes the vendor “Benedict's Grill”, a total of “$150.00”, and a date of “08/10/2019”.

Screen 400 includes a user interface control 412 that allows an account to be selected for transaction 338. Selecting control 412 may, for example, cause a window or menu to be displayed that lists the accounts of the given user and/or provides controls for adding a new account into which transaction 338 may be categorized. Screen 400 also includes a control 414 that, when selected, causes transaction 338 to be categorized into a recommended account. In this case, the recommended account is “Events”. The recommended account may have been determined by providing features of transaction 338 as inputs to model 128 of FIG. 1, and receiving the recommended account as an output from model 128 of FIG. 1. Because only the name of the account “Events” is known, this account may have been recommended based on its name being similar to names of accounts into which other users historically categorized similar transactions.

Once the user categorizes transaction 338, such as by selecting an account via control 412 or selecting the recommended account via control 414, the user's categorization of transaction 338 is used to generate training data for training model 128 of FIG. 1. Because transaction 338 was prioritized for display to the user based on factors such as vendor popularity and vendor categorization consistency, as well a probability of being co-categorized with transactions already categorized, the categorization of transaction 338 will provide valuable insight into the user's chart of accounts, and may allow other transactions of the user to be automatically categorized in an accurate manner.

### Example Operations for Transaction Categorization Though Active Learning

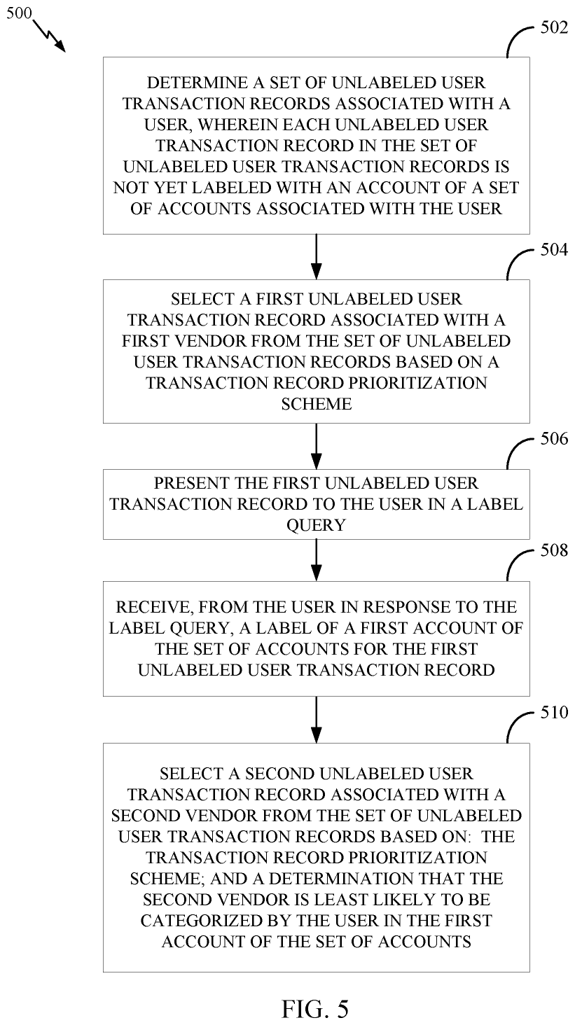

FIG. 5 depicts example operations 500 for transaction categorization through active learning. For example, operations 500 may be performed by one or more components of server 120 and/or client 130 of FIG. 1, and may relate to generating training data for training a machine learning model, such as model 128 of FIG. 1, to predict accounts into which transactions may be categorized.

At step 502, a set of unlabeled user transaction records associated with a user is determined, wherein each unlabeled user transaction record in the set of unlabeled user transaction records is not yet labeled with an account of a set of accounts associated with the user.

At step 504, a first unlabeled user transaction record associated with a first vendor is selected from the set of unlabeled user transaction records based on a transaction record prioritization scheme. The transaction record prioritization scheme may, for instance, consider factors such as vendor popularity by user (determined based on the set of unlabeled user transaction records and any labeled transaction records of the user), vendor popularity by region (determined based on labeled transaction records from all users in a given geographic region), vendor categorization consistency, and likelihood that a vendor will be co-categorized with a transaction that has already been categorized. Different factors may be weighted differently in the prioritization scheme, such as based on weights defined in advance by a provider of the application.

At step 506, the first unlabeled user transaction record is presented to the user in a label query. In some embodiments, a particular account of the set of accounts of the user is recommended to the user for the first unlabeled transaction record. The recommendation may be determined using a machine learning model.

At step 508, a label of a first account of the set of accounts for the first unlabeled user transaction record is received from the user in response to the label query.

At step 510, a second unlabeled user transaction record associated with a second vendor from the set of unlabeled user transaction records is selected based on: the transaction record prioritization scheme; and a determination that the second vendor is least likely to be categorized by the user in the first account of the set of accounts. The second unlabeled user transaction record may be presented to the user in a second label query, and a label of a second account of the set of accounts for the second unlabeled user transaction record may be received from the user in response to the second label query.

In some embodiments, a given account of the set of accounts of the user is recommended to the user for the second unlabeled transaction record. The recommendation may be determined using the machine learning model. The labels received from the user in response to the label queries may be used to generate training data for training the machine learning model so that future recommendations and/or automatic categorizations are more accurate for the user's set of accounts.

### Example Computing System

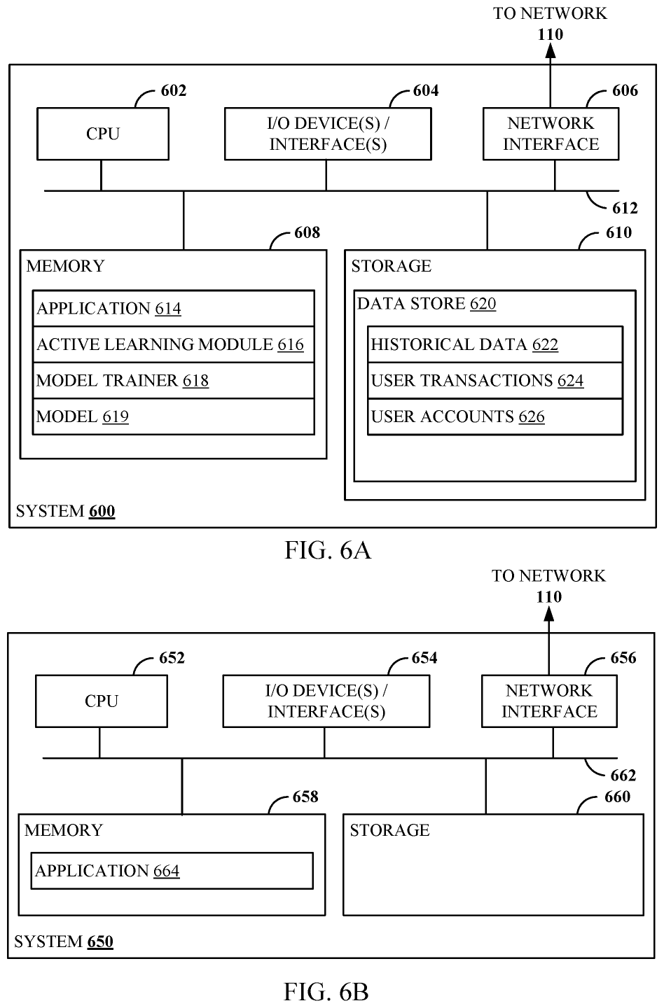

FIG. 6A illustrates an example system 600 with which embodiments of the present disclosure may be implemented. For example, system 600 may be representative of server 120 of FIG. 1.

System 600 includes a central processing unit (CPU) 602, one or more I/O device interfaces 604 that may allow for the connection of various I/O devices 614 (e.g., keyboards, displays, mouse devices, pen input, etc.) to the system 600, network interface 606, a memory 608, storage 610, and an interconnect 612. It is contemplated that one or more components of system 600 may be located remotely and accessed via a network. It is further contemplated that one or more components of system 600 may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, memory 608, and storage 610. CPU 602 is included to be representative of a single CPU, multiple CPUs, a single CPU having multiple processing cores, and other arrangements.

Additionally, the memory 608 is included to be representative of a random access memory. As shown, memory 608 includes application 614, active learning module 616, model trainer 618, and model 619, which may be representative of application 122, active learning module 124, model trainer 126, and model 128 of FIG. 1.

Storage 610 may be a disk drive, solid state drive, or a collection of storage devices distributed across multiple storage systems. Although shown as a single unit, the storage 610 may be a combination of fixed and/or removable storage devices, such as fixed disc drives, removable memory cards or optical storage, network attached storage (NAS), or a storage area-network (SAN).

Storage 610 comprises data store 620, which may be representative of data store 126 of FIG. 1. While data store 620 is depicted in local storage of system 600, it is noted that data store 620 may also be located remotely (e.g., at a location accessible over a network, such as the Internet). Data store 620 includes historical data 622, user transactions 624, and user accounts 626, which may be representative of historical transaction categorization data 142, user transactions 144, and user accounts 146 of FIG. 1.

FIG. 6B illustrates another example system 650 with which embodiments of the present disclosure may be implemented. For example, system 650 may be representative of client 130 of FIG. 1.

System 650 includes a central processing unit (CPU) 652, one or more I/O device interfaces 654 that may allow for the connection of various I/O devices 654 (e.g., keyboards, displays, mouse devices, pen input, etc.) to the system 650, network interface 656, a memory 658, storage 660, and an interconnect 662. It is contemplated that one or more components of system 650 may be located remotely and accessed via a network. It is further contemplated that one or more components of system 650 may comprise physical components or virtualized components.

CPU 652 may retrieve and execute programming instructions stored in the memory 658. Similarly, the CPU 652 may retrieve and store application data residing in the memory 658. The interconnect 662 transmits programming instructions and application data, among the CPU 652, I/O device interface 654, network interface 656, memory 658, and storage 660. CPU 652 is included to be representative of a single CPU, multiple CPUs, a single CPU having multiple processing cores, and other arrangements.

Additionally, the memory 658 is included to be representative of a random access memory. As shown, memory 658 includes an application 664, which may be representative of a client-side component corresponding to the server-side application 614 of FIG. 6A. For example, application 664 may comprise a user interface through which a user of system 650 interacts with application 614 of FIG. 6A. In alternative embodiments, application 614 is a standalone application that performs behavior prediction as described herein.

Storage 660 may be a disk drive, solid state drive, or a collection of storage devices distributed across multiple storage systems. Although shown as a single unit, the storage 610 may be a combination of fixed and/or removable storage devices, such as fixed disc drives, removable memory cards or optical storage, network attached storage (NAS), or a storage area-network (SAN).

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for training a machine learning model using active learning, comprising:
determining a set of unlabeled user transaction records associated with a user, wherein each unlabeled user transaction record in the set of unlabeled user transaction records is not yet labeled with an account of a set of accounts associated with the user;
selecting a first unlabeled user transaction record associated with a first vendor from the set of unlabeled user transaction records based on a transaction record prioritization scheme;
presenting the first unlabeled user transaction record to the user in a label query;
receiving, from the user in response to the label query, a label of a first account of the set of accounts for the first unlabeled user transaction record;
selecting a second unlabeled user transaction record associated with a second vendor from the set of unlabeled user transaction records based on:
the transaction record prioritization scheme; and
a determination that the second vendor is least likely to be categorized by the user in the first account of the set of accounts.

2. The method of claim 1, further comprising determining a vendor popularity by user based on the set of unlabeled user transaction records, wherein the transaction record prioritization scheme involves the vendor popularity by user.

3. The method of claim 1, further comprising determining a likelihood for each vendor of a plurality of vendors of being labeled by the user in the first account of the set of user accounts, wherein the transaction record prioritization scheme involves the likelihood for each vendor of the plurality of vendors of being labeled by the user in the first account of the set of user accounts.

4. The method of claim 1, further comprising determining a vendor popularity by region based on the set of unlabeled user transaction records, wherein the transaction record prioritization scheme involves the vendor popularity by region.

5. The method of claim 1, further comprising training a model based on the label of the first account of the set of accounts received from the user.

6. A method for training a machine learning model, comprising:
receiving transaction categorization data comprising a plurality of transaction records of a plurality of users categorized into a plurality of accounts of the plurality of users;
determining a set of unlabeled user transaction records associated with a user;
determining popularities of vendors in the set of unlabeled user transaction records associated with the user based on occurrences of the vendors in the plurality of transaction records of the plurality of users;
determining categorization consistencies of the vendors in the transaction categorization data;
selecting a first transaction record of the set of unlabeled user transaction records to display to the user for categorization based on the popularities of the vendors and the categorization consistencies of the vendors;
displaying the first transaction record; and
receiving, in response to the displaying, a categorization of the first transaction record into a given account of a set of accounts of the user.

7. The method of claim 6, further comprising:
determining, based on the transaction categorization data, likelihoods of additional vendors of the vendors to be categorized in a same account as a vendor of the first transaction record; and
selecting a second transaction record of the set of unlabeled user transaction records to display to the user for categorization based on the likelihoods.

8. The method of claim 6, further comprising selecting the plurality of users based on a determination that each respective user of the plurality of users is associated with a geographic region of the user.

9. The method of claim 6, further comprising determining user-level popularities of the vendors based on occurrences of the vendors in the set of accounts of the user, wherein selecting the first transaction record is based further on the user-level popularities of the vendors.

10. The method of claim 6, further comprising predicting a particular account of the set of accounts into which the first transaction record is likely to be categorized, wherein a recommendation of the particular account is displayed with the first transaction record.

11. The method of claim 6, wherein determining the categorization consistencies of the vendors in the transaction categorization data comprises, for a respective vendor of the vendors, determining whether multiple given transaction records involving the respective vendor for a respective user of the plurality of users are categorized into a same account of the plurality of accounts that is associated with the respective user in the transaction categorization data.

12. The method of claim 6, wherein selecting the first transaction record of the set of unlabeled user transaction records to display to the user for categorization based on the popularities of the vendors and the categorization consistencies of the vendors comprises determining priorities for the set of unlabeled user transaction records based on weights associated with the popularities of the vendors and the categorization consistencies of the vendors.

13. The method of claim 6, further comprising training a model based on the categorization of the first transaction record into the given account of the set of accounts of the user.

14. A system, comprising: one or more processors; and a memory comprising instructions that, when executed by the one or more processors, cause the system to perform a method for training a machine learning model, the method comprising:
receiving transaction categorization data comprising a plurality of transaction records of a plurality of users categorized into a plurality of accounts of the plurality of users;
determining a set of unlabeled user transaction records associated with a user;
determining popularities of vendors in the set of unlabeled user transaction records associated with the user based on occurrences of the vendors in the plurality of transaction records of the plurality of users;
determining categorization consistencies of the vendors in the transaction categorization data;
selecting a first transaction record of the set of unlabeled user transaction records to display to the user for categorization based on the popularities of the vendors and the categorization consistencies of the vendors;
displaying the first transaction record; and
receiving, in response to the displaying, a categorization of the first transaction record into a given account of a set of accounts of the user.

15. The system of claim 14, wherein the method further comprises:
determining, based on the transaction categorization data, likelihoods of additional vendors of the vendors to be categorized in a same account as a vendor of the first transaction record; and
selecting a second transaction record of the set of unlabeled user transaction records to display to the user for categorization based on the likelihoods.

16. The system of claim 14, wherein the method further comprises selecting the plurality of users based on a determination that each respective user of the plurality of users is associated with a geographic region of the user.

17. The system of claim 14, wherein the method further comprises determining user-level popularities of the vendors based on occurrences of the vendors in the set of accounts of the user, wherein selecting the first transaction record is based further on the user-level popularities of the vendors.

18. The system of claim 14, wherein the method further comprises predicting a particular account of the set of accounts into which the first transaction record is likely to be categorized, wherein a recommendation of the particular account is displayed with the first transaction record.

19. The system of claim 14, wherein determining the categorization consistencies of the vendors in the transaction categorization data comprises, for a respective vendor of the vendors, determining whether multiple given transaction records involving the respective vendor for a respective user of the plurality of users are categorized into a same account of the plurality of accounts that is associated with the respective user in the transaction categorization data.

20. The system of claim 14, wherein selecting the first transaction record of the set of unlabeled user transaction records to display to the user for categorization based on the popularities of the vendors and the categorization consistencies of the vendors comprises determining priorities for the set of unlabeled user transaction records based on weights associated with the popularities of the vendors and the categorization consistencies of the vendors.
